(19) United States
(12) Patent Application Publication
(10) Pub. No.: US 2026/0193491 A1
(43) Pub. Date: Jul. 9, 2026

(54) EXPANDABLE EPOXY COMPOSITIONS FOR LOW TEMPERATURE CURING AND STRUCTURAL ADHESIVE THEREFROM, AND METHODS OF USING SAME

(71) Applicant: Henkel AG & Co. KGaA, Duesseldorf (DE)

(72) Inventors: Yuan Zhao, Shanghai (CN); Jinfeng Zhong, Shanghai (CN); Qi Chen, Shanghai (CN); Xuewen Zhang, Shanghai (CN)

(21) Appl. No.: 19/550,795

(22) Filed: Feb. 26, 2026

Related U.S. Application Data
(63) Continuation of application No. PCT/CN2023/118154, filed on Sep. 12, 2023.

(51) Int. Cl. C09J 5/08; C08J 9/00; C08J 9/10; C08J 9/12; C08K 5/17; C08K 5/21; C08K 5/315; C08K 5/3445; C09J 5/06; C09J 11/08; C09J 163/00

(52) U.S. Cl. CPC C09J 5/08; C08J 9/0028; C08J 9/102; C08J 9/12; C08K 5/17; C08K 5/21; C08K 5/3155; C08K 5/3445; C09J 5/06; C09J 11/08; C09J 163/00; C08J 2203/04; C08J 2203/22; C08J 2207/02; C08J 2363/02; C08J 2409/02; C08J 2471/00; C09J 2400/163

(57) ABSTRACT

This invention relates to an expandable epoxy composition comprising at least one epoxy resin, a toughening agent, an accelerant, a foaming agent, a curing agent, which can be cured and foamed at low temperature, e.g., 120° C., along with related methods of making and using the same, for structural adhesives after curing and foaming, for example, in automotive industrial bonding applications, which provides particularly good impact peel strength, good storage ability and the expandable epoxy compositions could be cured/foamed at low temperature.

### TECHNICAL FIELD

The present disclosure relates to expandable epoxy compositions for low temperature curing, structural adhesives therefrom and assemblies, along with related methods of using the same. The expandable epoxy compositions and structural adhesives can be used, for example, in automotive industrial bonding applications.

### BACKGROUND OF THE INVENTION

With the increase in the use of adhesives for both vehicle assembly and vehicle repair. Industry sources have predicted a sustaining structural adhesive market growth annually. During both vehicle assembly and collision repairs, structural adhesives are typically used along with mechanical fasteners or spot welding which is referred to as cold joining using a hybrid joint. The joint is considered a hybrid because it uses both an adhesive and a fastener together. Hybrid joining combines the strengths of both the adhesive and the fastener together to overcome their individual vulnerabilities.

Highly toughened, expandable structural adhesives reliably join gaps while adding strength and rigidity to body-in-white structures, chassis, and closures. When used in vehicle body construction between sheet metal cavities, these hybrid epoxy adhesives enhance the structural performance of the vehicle with minimal weight penalty as compared to alternative solutions. These products provide superior joint quality with better adhesion in areas difficult to bond with their non-expanding counter parts. The technology has been successfully implemented in body shops to reinforce roof structures, panoramic roofs, and body structures to improve crashworthiness.

AS some OEMs find the cavities are always at lower temperature than the e-coating temperature, and request for expandable adhesives which could be cured and foamed at lower temperature and for shorter curing and foaming time in the cavities. Thus, the expandable adhesive needs high expanding rate even at a temperature equal to or lower than 160° C., or lower than 150° C., or lower than 140° C. and for curing time of at least 10 mins, or at least 15 mins, or at least 20 mins. Therefore, there remains a need to low temperature curing and foaming expandable epoxy compositions which have technically equivalent of mechanical property to traditional epoxy compositions, and the compositions can be easy to prepare by low temperature curing and foaming procedure without additional heating steps on an industrial production line.

### SUMMARY OF THE INVENTION

It is therefore the object of the present invention to overcome the above-mentioned drawbacks by providing a high-performance expandable epoxy based structural adhesive composition which has excellent strength and bonding performance after curing and foaming at a low curing temperature, such as 120° C.-160° C., and good expanding rate. The structural adhesive can use for cavity filling and structural bonding.

It has been surprisingly found that structural adhesive prepared from an expandable epoxy composition comprising at least an epoxy resin; a toughening agent; an accelerant, a foaming agent and a curing agent, provides very good strength properties within a broad operating (curing and foaming) temperature range, e.g., from greater than 120° C. to 205° C.

According to one aspect, the present invention relates to an expandable epoxy composition, comprising an epoxy resin, a toughening agent, an accelerant, a foaming agent, a curing agent, wherein the expandable epoxy composition has a T peel strength pursuant to ASTM D1876 at 23° C. of equal to or greater than 6 N/mm, a shear strength pursuant to SAE J1523 at 23° C. of equal to or greater than 6 MPa, and an expanding rate % of equal to or greater than 50%, after curing and foaming the expandable epoxy composition at 140° C. for 15 minutes.

According to one aspect, the present invention is directed to a method of using an expandable epoxy composition which comprises applying an expandable epoxy composition of present invention on a first substrate of an article; optionally, attaching a second substrate to the first substrate, and curing and foaming the article at a temperature of from 120° C. to 205° C. for at least 20 to 5 mins.

According to still another aspect, the present invention also relates to a structural adhesive comprising a cured and foamed product of the expandable epoxy composition according to present invention.

In still another aspect, the present invention is directed to an article comprising a first substrate, a second substrate and a cured/foamed composition disposed between and adhering the first substrate and the second substrate, wherein the cured/foamed composition is the cured/foamed product of the expandable epoxy composition according to present invention.

According to still another aspect, the present invention also relates to an automotive frame, comprises an article of present invention.

### DETAILED DESCRIPTION OF THE INVENTION

In the following passages the present invention is described in more detail. Each aspect so described may be combined with any other aspect or aspects unless clearly indicated to the contrary. In particularly, any feature indicated as being preferred or advantageous may be combined with any other feature or features indicated as being preferred or advantageous.

In the context of the present invention, the terms used are to be construed in accordance with the following definitions, unless a context dictates otherwise.

As used herein, the singular forms “a”, “an” and “the” include both singular and plural referents unless the context clearly dictates otherwise. For example, reference to “a filler” encompasses embodiments having one, two or more fillers. As used in this specification and the appended claims, the term “or” is generally employed in its sense including “and/or” unless the content clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements, or process steps.

The term “room temperature” refers to a temperature in the range of 20° C. to 25° C., inclusive.

The recitation of numerical end points includes all numbers and fractions subsumed within the respective ranges, as well as the recited end points.

Unless otherwise defined, all terms used in the disclosing the invention, including technical and scientific terms, have the meaning as commonly understood by one of the ordinary skills in the art to which this invention belongs to. By means of further guidance, term definitions are included to better appreciate the teaching of the present invention.

In the context of this disclosure, several terms shall be utilized.

The terms “polymer” is used herein consistent with its common usage in chemistry. Polymers are composed of many repeated subunits. The term “polymer” is used to describe the resultant material formed from a polymerization reaction.

As used herein, the term “cure” refers to exposing to radiation in any form, heating, or allowing to undergo a physical or chemical reaction that results in hardening or an increase in viscosity.

As discussed previously, embodiments of the present disclosure are directed to an expandable epoxy composition comprising at least an epoxy resin; a toughening agent; an accelerant, a foaming agent and a curing agent.

### Epoxy Resin

The expandable epoxy composition comprises at least one epoxy resin. Suitable epoxy resins include the diglycidyl ethers of polyhydric phenol compounds such as resorcinol, catechol, hydroquinone, bisphenol, bisphenol A, bisphenol AP (1,1-bis(4-hydroxylphenyl)-1-phenyl ethane), bisphenol F, bisphenol K, bisphenol M, tetramethylbisphenol, diglycidyl ethers of aliphatic glycols and polyether glycols such as the diglycidyl ethers of C2-24 alkylene glycols and poly(ethylene oxide) or poly(propylene oxide) glycols; polyglycidyl ethers of phenol-formaldehyde novolac resins, alkyl substituted phenol-formaldehyde resins (epoxy novalac resins), phenol-hydroxybenzaldehyde resins, cresol-hydroxybenzaldehyde resins, dicyclopentadiene-phenol resins and dicyclopentadiene-substituted phenol resins, and any combination thereof.

Commercially available epoxy resins include those sold as DER 331 by Dow Chemical, EPON 828 by Hexion, YD 128 by Kukdo Chemical.

Other suitable additional epoxy resins are cycloaliphatic epoxides. A cycloaliphatic epoxide includes a saturated carbon ring having an epoxy oxygen bonded to two vicinal atoms in the carbon ring, as illustrated by the following structure I:

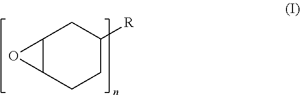

wherein R is an aliphatic, cycloaliphatic and/or aromatic group and n is a number from 1 to 10, preferably from 2 to 4. When n is 1, the cycloaliphatic epoxide is a monoepoxide. Dior epoxy resins are formed when n is 2 or more. Mixtures of mono-, di- and/or epoxy resins can be used. Cycloaliphatic epoxy resins of particular interest are (3,4-epoxycyclohexyl-methyl)-3,4-epoxy-cyclohexane carboxylate, bis-(3,4-epoxycyclohexyl) adipate, vinylcyclohexene monoxide and mixtures thereof.

The epoxy resin preferably is a bisphenol-type epoxy resin or mixture thereof with up to 10 percent by weight of another type of epoxy resin. Preferably the bisphenol type epoxy resin is a liquid epoxy resin, or a mixture of a solid epoxy resin dispersed in a liquid epoxy resin. The most preferred epoxy resins are bisphenol-A based epoxy resins and bisphenol-F based epoxy resins.

An especially preferred epoxy resin is a mixture of a diglycidyl ether of at least one polyhydric phenol, preferably bisphenol-A or bisphenol-F, having an epoxy equivalent weight of from 170 to 299, especially from 170 to 225, and at least one second diglycidyl ether of a polyhydric phenol, again preferably bisphenol-A or bisphenol-F, this one having an epoxy equivalent weight of at least 300, preferably from 310 to 600. The proportions of the two types of resins are preferably such that the mixture of the two resins has an average epoxy equivalent weight of from 225 to 400.

In embodiments of the present invention, the expandable epoxy composition comprising, at least 10 parts by weight, or at least about 15 parts by weight, or at least about 20 parts by weight of the epoxy resin. In some preferred embodiments, up to about 45 parts by weight, or up to about 40 parts by weight, or up to about 35 parts by weight, or up to about 30 parts by weight of the epoxy resin. A preferred amount includes 10-45 parts by weight, or 15-30 prats by weight.

### Toughening Agent

The expandable epoxy composition of the present invention comprises at least a toughening agent.

In some embodiments, the toughening agent comprises acrylonitrile rubber, core-shell rubber, polyetheramine.

The core-shell rubber component is a particulate material having a rubbery core. The rubbery core preferably has a Tg of less than −25° C., more preferably less than −50° C., and even more preferably less than −70° C. The Tg of the rubbery core may be well below −100° C. The core-shell rubber also has at least one shell portion that preferably has a Tg of at least 50° C. By “core,” it is meant an internal portion of the core-shell rubber.

The core may form the centre of the core-shell particle, or an internal shell or domain of the core-shell rubber. A shell is a portion of the core-shell rubber that is exterior to the rubbery core. The shell portion (or portions) typically forms the outermost portion of the core-shell rubber particle. The shell material is preferably grafted onto the core or is crosslinked. The rubbery core may constitute from 50 to 95%, especially from 60 to 90%, of the weight of the core-shell rubber particle.

The core of the core-shell rubber may be a polymer or copolymer of a conjugated diene such as butadiene, or a lower alkyl acrylate such as n-butyl-, ethyl-, isobutyl- or 2-ethylhexylacrylate. The core polymer may in addition contain up to 20% by weight of other copolymerized monounsaturated monomers such as styrene, vinyl acetate, vinyl chloride, methyl methacrylate, and the like. The core polymer is optionally crosslinked. The core polymer optionally contains up to 5% of a copolymerized graft-linking monomer having two or more sites of unsaturation of unequal reactivity, such as diallyl maleate, monoallyl fumarate, allyl methacrylate, and the like, at least one of the reactive sites being non-conjugated.

The core polymer may also be a silicone rubber. These materials often have glass transition temperatures below −100° C. Core-shell rubbers having a silicone rubber core include those commercially available from Wacker Chemie AG, Munich, Germany, under the trade name Genioperl.

The shell polymer, which is optionally chemically grafted or crosslinked to the rubber core, is preferably polymerized from at least one lower alkyl methacrylate such as methyl methacrylate, ethyl methacrylate or t-butyl methacrylate. Homopolymers of such methacrylate monomers can be used. Further, up to 40% by weight of the shell polymer can be formed from other monovinylidene monomers such as styrene, vinyl acetate, vinyl chloride, methyl acrylate, ethyl acrylate, butyl acrylate, and the like. The molecular weight of the grafted shell polymer is generally between 20,000 and 500,000.

A preferred type of core-shell rubber has reactive groups in the shell polymer which can react with an epoxy resin or an epoxy resin hardener. Glycidyl groups are suitable. These can be provided by monomers such as glycidyl methacrylate.

Examples of commercially available core-shell rubbers include, for example, those sold by Kaneka Corporation under the designation Kaneka Kane Ace, including the Kaneka Kane Ace 15 and 120 series of products, including Kaneka Kane Ace MX 153, Kaneka Kane Ace MX 156, Kaneka Kane Ace MX 257 and Kaneka Kane Ace MX 120 core-shell rubber dispersions, and mixtures thereof. The products contain the core-shell rubber particles pre-dispersed in an epoxy resin, at concentrations of approximately 33% or 25%.

In some of the embodiments, the toughening agent comprises capped polyurethane prepolymer and polyetheramine-epoxy prepolymer. The polyetheramine-epoxy prepolymer being a reaction product of a difunctional epoxy, a rubber dicarboxylic acid or a rubber diamine and a polyamine comprising aliphatic chain. The difunctional epoxy being selected from bisphenol A, or bisphenol F, or bisphenol S, or halogenated bisphenol; the rubber dicarboxylic acid and the rubber diamine, the rubber chain being selected from polybutadiene, or polyacrylonitrile, or polypentadiene; the polyamine comprising aliphatic chain being selected from polyamine having aliphatic chain of 10 to 400 carbon atoms. In some embodiments, the expandable epoxy composition comprises from 5 to 30 or 10 to 25 parts by weight of the polyetheramine-epoxy prepolymer.

15-60 parts by weight of toughening agent may be used. The expandable epoxy composition of the invention preferably has a total toughening agent content of at least 15 parts by weight, or at least 18 parts by weight, or at least 20 parts by weight, or at least 25 parts by weight. The epoxy-based structural adhesive of the invention preferably has a total toughening agent content up to 60 parts by weight, or up to 50 parts by weight. A preferred amount includes 20-50 prats by weight, or 25-50 prats by weight.

### Accelerant

The expandable epoxy composition of the present invention comprises at least an accelerant selected from substituted amine, substituted imidazole and a combination of substituted imidazole, and substituted urea.

In some embodiments, the accelerant comprises a substituted amine.

Examples of commercial products of substituted amine curing accelerants include FUJICURE FXR-1020 (m.p.=115-130° C.), FUJICURE FXR-1030 (m.p.=135-145° C.), FUJICURE FXR-1081 (m.p.=115-125° C.), FUJICURE FXR-1090FA (m.p.=110-120° C.), FUJICURE FXR-1121 (128-138° C.), SANCURE LC-125 (110-125° C.) from T&K Toka co, Ltd. Tokyo, Japan.

In some embodiments, the accelerant comprises a substituted imidazole. The substituted imidazole is selected from 1-N substituted imidazole, 2-C substituted imidazole, and imidazole metal salts.

In some embodiments, the accelerant comprises a combination of substituted imidazole and substituted urea. The substituted urea comprises disubstituted urea.

Examples of commercial products of substituted imidazole curing accelerants include CUREZOL 2PHZ-S, CUREZOL 2MZ-AZINE and CUREZOL 2MA-OK from Air Products and Chemicals. Examples of commercial products of substituted urea curing accelerants include Dyhard UR 700 and Dyhard UR 700 from Evonik.

Any effective amount of curing accelerants may be used in the present invention. The adhesive composition of the invention preferably has a total curing accelerants content of at least 0.1 parts by weight, or at least 0.3 parts by weight, or at least 0.5 parts by weight, or at least 0.8 parts by weight, or at least 1.0 parts by weight. The epoxy adhesive of the invention preferably has a total curing accelerants content up to 4.0 parts by weight, more preferably up to 3.5 parts by weight, more preferably up to 3.2 parts by weight.

In some embodiments, the accelerant comprises a substituted amine in an amount of 1.0-4.0 parts by weight, or 2.0-3.5 parts by weight.

In some embodiments, the accelerant comprises a substituted imidazole in an amount of 0.3-1.0 parts by weight, or 0.35-0.9 parts by weight.

In some embodiments, the accelerant comprises a combination of substituted imidazole and substituted urea in an amount of 0.5-1.5 parts by weight, or 0.6-1.0 parts by weight, or 0.7-0.9 parts by weight. And the mass ratio of the substituted imidazole to the substituted urea is from 1:2 to 4:1. In addition, excess amount of substituted imidazole in the expandable epoxy compositions may cause gelation and impact the storage stability. To possess a good storage stability, the mass amount of the substituted imidazole is at most 1.5 parts by weight in the epoxy composition.

### Curing Agent

Any curing agents (hardener) appropriate for a one-component (IK) epoxy adhesive may be used. As is known in the art, a one component epoxy adhesive contains all of the ingredients for the adhesive in a single composition and does not cure until exposed to the appropriate conditions (e.g., heat or radiation), which activates the latent hardener.

The hardener, preferably for a one component adhesive composition, preferably comprises a latent hardener. Any latent hardener that does not cause hardening under ambient conditions (“ambient conditions” meaning, e.g., typical room temperature and normal lighting conditions) may be used. A latent hardener that causes the epoxy adhesive to be curable by application of heat is preferred. Some preferred hardeners include dicyandiamide, imidazoles, amines, amides, polyhydric phenols, and polyanhydrides. Dicyandiamide (also known as DICY, dicyanodiamide, and 1- or 2-cyanoguanidine) is preferred.

Any amount of hardener may be used as appropriate for any particular composition according to the present invention. The effective amount of hardener is preferably at least 1 part by weight, or at least 2 parts by weight, or at least 3 parts by weight, or at least 3.5 parts by weight. The amount of epoxy hardener is preferably up to about 5 parts by weight, or up to about 4 parts by weight. Some preferred amounts include 3.1, 3.3, 3.5 and 3.6 parts by weight.

Examples of commercially available sources of the hardeners are, for example, DYHARD 100 SH from Evonik, OMICURE DDA 5 from Huntsman, AMICURE CG1200 from Evonik.

### Optional Additives

### Diluent

Optional additives include epoxy resin diluent.

Epoxy resin diluent include a wide variety of epoxy resin compounds. Any epoxy diluent compound that improves the mechanical and thermal performance of the final composition is preferably used as the epoxy resin diluent composition. For example, the epoxy diluents, (or polyepoxides) useful in the present invention may include aliphatic, cycloaliphatic, aromatic, hetero-cyclic epoxy diluents, and mixtures thereof. In one preferred embodiment, the epoxy diluent may contain, on average, one or more reactive oxirane groups. Epoxy resins useful in the embodiments described herein may include for example mono-functional epoxy resins, multi- or poly-functional epoxy resins, and combinations thereof.

Suitable examples of the epoxy resin diluent useful in the present invention may include, but are not limited to, butyl glycidyl ether (BGE), phenyl glycidyl ether (PGE), cresol glycidyl ether (CGE), benzyl glycidyl ether, p-tert-butylphenyl glycidyl ether, 2-ethyl hexyl glycidyl ether, decyl glycidyl ether, alkyl (C12-C14) glycidyl ether (AGE), polyglycol diglycidyl ether, polypropylene diglycidyl ether, 1,4-butanediol diglycidyl ether (BDDGE), 1,6-hexanediol diglycidyl ether (HDDGE), ethylene glycol diglycidyl ether, neopentane glycol diglycidyl ether, resorcinol diglycidyl ether, trimethyl propane triglycidyl ether (TMPTGE); and mixtures thereof.

Other examples of the epoxy resin diluent may include commercially available resins such as D.E.R.™ 331, D.E.R. 337, D.E.R. 736 and mixtures thereof. The above D.E.R. epoxy resins are commercial products available from Dow Chemical Company.

### Filler

Optional additives also include some fillers which could increase the thixotropic, decrease density or keep modulus.

In some embodiments, the composition of the present invention comprises known fillers such as various ground or precipitated chalk, quartz powder, alumina, non-flaky clay, dolomite, carbon fiber, glass fiber, polymeric fibers, titanium dioxide, calcined silica, carbon black, calcium oxide, calcium carbonate, calcium magnesium carbonate, barite, and especially silicate-like fillers of the type of aluminum magnesium silicate calcium, such as wollastonite and chlorite.

In yet other embodiments, hollow glass bubbles are present in the composition as fillers. Commercially available hollow glass bubbles include materials sold under the trademark SCOTCHLITE by 3M, and suitable grades include those available under the names B38, C15, K₂O, and VS5500. The hollow glass microspheres preferably have a diameter of about 5-200 microns and/or a density of about 0.3 to about 0.5 g/cc. Generally, the composition may contain about 0.5 to about 5 parts by weight of hollow glass bubbles.

In some embodiments, filler loadings may be at least 10 parts by weight, or at least 20 parts by weight, or at least 30 parts by weight, or at least 35 parts by weight. In some embodiments, filler loadings may be 5-40 parts by weight, or 10-35 parts by weight, or 5-35 parts by weight, or 20-35 parts by weight.

### Preparing Method of the Expandable Epoxy Composition

Methods according to the present invention also include obtaining (e.g., manufacturing; purchasing; mixing components of a 1K expandable epoxy composition; etc.) a structural adhesive according to the present invention and exposing the expandable epoxy composition to conditions to partially or completely cure the epoxy adhesive composition to form a structural adhesive.

In some embodiments of the present invention, the multifunctional epoxy-terminated prepolymer is preferably prepared by steps of: mixing the difunctional epoxy and the polyamine heating the mixture at 100-150° C. with mixer for 2-5 h.

As used herein, “Mw” refers to the weight average molecular weight and means the theoretical value as determined by Gel Permeation Chromatography (GPC) relative to linear polystyrene standards of 1.1 M to 580 Da and may be performed using Waters 2695 separation module with a Waters 2414 differential refractometer (RI detector).

### Curing/Foaming Method of the Expandable Epoxy Composition

In some embodiments of the present invention, the expandable epoxy composition is in liquid phase at room temperature before curing and foaming. The expandable epoxy composition is preferably cured by steps of:
a) Treating the cold rolled steel (CRS) sample.
b) Applying the expandable epoxy composition on the treated surface of the sample.
c) Curing the sample at a certain temperature for a certain time.

### Listing of Embodiments

1. An expandable epoxy composition, comprising an epoxy resin, a toughening agent, an accelerant, a foaming agent, a curing agent, wherein the expandable epoxy composition has a T peel strength pursuant to ASTM D1876 at 23° C. of equal to or greater than 6 N/mm, a shear strength pursuant to SAE J1523 at 23° C. of equal to or greater than 6 MPa, and an expanding rate % of equal to or greater than 50%, after curing and foaming the expandable epoxy composition at 140° C. for 15 minutes.
2. The expandable epoxy composition of embodiment 1, wherein the expandable epoxy composition has a shear strength pursuant to SAE J1523 at 23° C. of equal to or greater than 7 MPa.
3. The expandable epoxy composition of any one of preceding embodiments, wherein the expandable epoxy composition has a T peel strength pursuant to ASTM D1876 at 23° C. of equal to or greater than 6 N/mm, a shear strength pursuant to SAE J1523 at 23° C. of equal to or greater than 6 MPa, and an expanding rate % of equal to or greater than 50%, after curing and foaming the expandable epoxy composition at 140° C. for 20 minutes.
4. The expandable epoxy composition of any one of preceding embodiments, wherein the expandable epoxy composition has a T peel strength pursuant to ASTM D1876 at 23° C. of equal to or greater than 6 N/mm, a shear strength pursuant to SAE J1523 at 23° C. of equal to or greater than 6 MPa, and an expanding rate % of equal to or greater than 50%, after curing and foaming the expandable epoxy composition at 150° C. for 10 minutes.
5. The expandable epoxy composition of any one of preceding embodiments, wherein the expandable epoxy composition has a T peel strength pursuant to ASTM D1876 at 23° C. of equal to or greater than 6 N/mm, a shear strength pursuant to SAE J1523 at 23° C. of equal to or greater than 6 MPa, and an expanding rate % of equal to or greater than 50%, after curing and foaming the expandable epoxy composition at 160° C. for 10 minutes.
6. The expandable epoxy composition of any one of preceding embodiments, wherein the expandable epoxy composition has a T peel strength pursuant to ASTM D1876 at 23° C. of equal to or greater than 6 N/mm, a shear strength pursuant to SAE J1523 at 23° C. of equal to or greater than 6 MPa, and an expanding rate % of equal to or greater than 50%, after curing and foaming the expandable epoxy composition at 180° C. for 10 minutes.
7. The expandable epoxy composition any one of preceding embodiments, wherein the expandable epoxy composition comprising:
a) at least one epoxy resin present in an amount of 10-45 parts by weight,
b) a toughening agent present in an amount of 15-60 parts by weight,
c) an accelerant present in 0.1-4.0 parts by weight,
d) a foaming agent present in 0.5-3.0 parts by weight,
e) an effective amount of a curing agent,
wherein the accelerant comprising at least a substituted amine, a substituted imidazole or a combination of substituted urea and substituted imidazole, and the foaming agent comprising at least a chemical foaming agent, a physical foaming agent or a combination thereof.
8. The expandable epoxy composition of embodiment 7, wherein the at least one epoxy resin is selected from the group consisting of diglycidyl ethers of bisphenol A or bisphenol F.
9. The expandable epoxy composition of any one of embodiments 7-8, wherein the expandable epoxy composition comprises from 15 to 30 parts by weight of the epoxy resin.
10. The expandable epoxy composition of any one of embodiments 7-9, wherein the accelerant comprises a substituted amine in an amount of 1.0-4.0 parts by weight.
11. The expandable epoxy composition of any one of embodiments 7-10, wherein the accelerant comprises a substituted imidazole in an amount of 0.3-1.0 parts by weight.
12. The expandable epoxy composition of any one of embodiments 7-11, wherein the accelerant comprises a combination of substituted urea and substituted imidazole in an amount of 0.5-1.5 parts by weight.
13. The expandable epoxy composition of embodiment 12, wherein the mass ratio of the substituted imidazole to the substituted urea is from 1:2 to 4:1.
14. The expandable epoxy composition of any one of embodiments 7-13, wherein the chemical foaming agent comprising azo-compound and the physical foaming agent comprising expanded microspheres.
15. The expandable epoxy composition of any one of embodiments 7-14, wherein the toughening agent comprises one or more selected from rubber, capped polyurethane prepolymer and polyetheramine-epoxy prepolymer.
16. The expandable epoxy composition of embodiment 15, wherein the polyetheramine-epoxy prepolymer being a reaction product of:
a) a difunctional epoxy;
b) a rubber dicarboxylic acid or a rubber diamine; and
c) a polyamine comprising aliphatic chain,
wherein the difunctional epoxy being selected from bisphenol A, or bisphenol F, or bisphenol S, or halogenated bisphenol; the rubber dicarboxylic acid and the rubber diamine, the rubber chain being selected from polybutadiene, or polyacrylonitrile, or polypentadiene; the polyamine comprising aliphatic chain being selected from polyamine having aliphatic chain of 10 to 400 carbon atoms.
17. The expandable epoxy composition of any one of embodiments 7-16, wherein the expandable epoxy composition comprises from 5 to 30 or 10 to 25 parts by weight of the polyetheramine-epoxy prepolymer.
18. A method of using an expandable epoxy composition which comprises:
a) applying an expandable epoxy composition of at least one of embodiments 1 to 17 on a first substrate of an article;
b) optionally, attaching a second substrate to the first substrate, and
c) curing and foaming the article at a temperature of from 120° C. to 205° C. for at least 20 to 5 mins.
19. The method of embodiment 18, wherein curing and foaming the article at a temperature of from 140° C. to 180° C. for at least 15 to 7 mins.
20. The method of any one of embodiment 18-19, wherein at least one of the substrates is metal.
21. A structural adhesive comprising a cured and foamed product of the expandable epoxy composition according to any one of embodiments 1-17.
22. An article comprising a first substrate, a second substrate and a cured/foamed composition disposed between and adhering the first substrate and the second substrate, wherein the cured/foamed composition is the cured/foamed product of the expandable epoxy composition according to any one of embodiments 1-17.
23. An automotive frame, comprises an article of embodiment 22.

### EXAMPLES

The present invention will be further described and illustrated in detail with reference to the following examples. The examples are intended to assist one skilled in the art to better understand and practice the present invention, however, are not intended to restrict the scope of the present invention. All numbers in the examples are based on weight unless otherwise stated.

### Raw Materials

| Product name | Description/function | Source |
|---|---|---|
| DER 331 | Bisphenol A epoxy | DOW chemical (Midland, MI, US) |
| JEFFAMINE D-2000 | Polyetheramine | Huntsman Corporation |
| DN 124 | Acrylonitrile rubber | Zeon Chemicals Nipol |
| MX 154 | Core-shell rubber epoxy | Kaneka |
| QR 9466 | Capped polyurethane prepolymer | Adeka (Tokyo, Japan) |
| DYHARD UR 700 | Accelerant (substituted urea) | Evonik (Essen, Germany) |
| DYHARD UR 500 | Accelerant (substituted urea) | Evonik (Essen, Germany) |
| Fujicure FXR 1030 | Accelerant (substituted amine) | T&K Toka co, Ltd. Tokyo, Japan |
| 2MAOK-PW | Accelerant (substituted imidazole) | Air products and chemicals, Inc, |
| | | Allentown, PA |
| 2P4MHZ-PW | Accelerant (substituted imidazole) | Air products and chemicals, Inc, |
| | | Allentown, PA |
| OMICURE U52 | Accelerant (substituted urea) | Hunstman (The Woodlands, TX, |
| Dyhard 100 SH | Curing agent | Evonik (Essen, Germany) |
| OMYACARB 2 | CaCO₃ | Omya (Shanghai, China) |
| CaO | CaO | Guoyao (Shanghai, China) |
| GARAMITE 7305 | Organophilic phyllosilicates | BYK Chemie (Wesel, Germany) |
| XY 966 | Diluent | Anhui Xinyuan |
| Cellcom AC7000F | Chemical foaming agent | Kum Yang Co. Ltd. |
| CF 810 | Chemical foaming agent | Kum Yang Co. Ltd. |
| 051 DU 40 | Expanded microsphere | Akzo Nobel |
| 909 DU 80 | Expanded microsphere | Akzo Nobel |

* All raw materials are directly used without any special treatment.

### Preparation of Polyetheramine

For the synthesis of Polyetheramine DGEBA (diglycidyl ether of the bisphenol-A), bisphenol A liquid epoxy resin DER 331 (300 g) and JEFFAMINE D-2000 polyetheramine (200 g) were added into a reactor. Then the mixture was heated to 120° C. and stirred for 4 h. When the reaction was stopped, the Polyetheramine DGEBA was obtained.

### Example 1

### Preparation of Expandable Epoxy Composition

For the preparation of expandable epoxy composition E1, DER 331 (17 g), MX 154 (31 g), QR9466 (9 g), Polyetheramine-DGEBA (10 g) and XY996 (4 g), were added into a container and mixed by Speedmixer for 1 min at 1000 rpm. Then, 2MAOK-PW (0.53 g), OMICURE U52 (0.35 g), Dyhard 100 SH (3.5 g), CaCO₃ (20 g), CaO (2 g), Garamite 7305 (2 g) and Cellcom AC7000F (1.6 g) were added into the system and mixed by Speedmixer for 1 min at 1600 rpm for twice, vacuum is needed during mixing. During the preparation, the temperature must be kept under 40° C.

### Curing/Foaming of Expandable Epoxy Composition

The coupons of cold rolled steel (CRS) were washed with acetone and wiped with paper towels, after which 3 g/m² FERROCOTE 61AUS oil was coated on one side. The adhesive was then heat-coated on the oiled surface of the sample. Spacer (1 mm) were put on the substrate before covering the test specimen. The metal clamp was used to clamp the two samples together during the baking cycle. All samples/adhesive assemblies were cured/foamed at different curing/foaming conditions separately:
1) 15 minutes at 140° C., and then 24 hours at room temperature,
2) 20 minutes at 140° C., and then 24 hours at room temperature,
3) 10 minutes at 150° C., and then 24 hours at room temperature,
4) 10 minutes at 160° C., and then 24 hours at room temperature,
5) 10 minutes at 180° C., and then 24 hours at room temperature,
6) 20 minutes at 180° C., and then 24 hours at room temperature, or
7) 30 minutes at 205° C., and then 24 hours at room temperature.
   The cured structural adhesive samples were subjected to various tests.

### Example 2-10, and CE1-CE4

The expandable epoxy compositions of E2 to E10, CE1 to CE4 were prepared in reference to Example 1. The expandable epoxy composition of E2 to E10 and CE1 to CE4 were cured in reference to Example 1. More details are listed in below results.

### Test Methods

### Shear Strength

Shear strength pursuant to SAE J1523. The sample suitable for the shear test has a 12.5 mm cover and a width of 25 mm and is pulled at a speed of 5 mm/min using an Instron tester at 23° C. The plateau average load is used to calculate the shear strength.

Shear strength results are recorded and ranked as follows:
Not pass: lower than 6 MPa;
Pass: greater than or equal to 6 MPa;
Good: greater than or equal to 7 MPa;
Excellent: greater than or equal to 8 MPa.

### T-Peel Strength

T peel strength pursuant to ASTM D1876. The sample suitable for the t-peel test has a 100 mm cover and a width of 25 mm and is pulled at a speed of 50 mm/min using an Instron tester at 23° C. The plateau average load is used to calculate the peel strength.

T-peel strength results are recorded and ranked as follows:
Not pass: lower than 6 N/mm;
Pass: greater than or equal to 6 N/mm;
Good: greater than or equal to 7 N/mm;
Excellent: greater than or equal to 8 N/mm.

### Expanding Rate

The expanding rate is quantified for each sample by measuring the density of a bead of test material with approximately 5 mm radius and a length of 50 mm before and after expansion at 23° C. The densities were determined according to DIN EN ISO 1183 using the water immersion method (Archimedes principle) in deionized water and a precision balance to measure the mass. Expanding rate-(density before curing/density after curing)*100%.

Expanding rate results are recorded and ranked as follows:
Not pass: lower than 50%;
Pass: greater than or equal to 50%;
Good: greater than or equal to 80%;
Excellent: greater than or equal to 100%.

TABLE 1

| Product name | E1 | E2 | E3 | E4 | E5 | E6 | E7 | E8 | E9 | E10 | CE 1 | CE 2 | CE 3 | CE 4 |
|---|---|---|---|---|---|---|---|---|---|---|---|---|---|---|
| DER 331 | 17 | 17 | 17 | 17 | 30 | 30 | 30 | 30 | 30 | 17 | 17 | 17 | 20 | 25 |
| MX 154 | 31 | 31 | 31 | 31 | | | | | | 50 | 31 | 31 | 28 | 23 |
| DN 124 | | | | | 4 | 4 | 4 | 4 | 4 | | | | | |
| QR 9466 | 9 | 9 | 9 | 9 | | | | | | | 9 | 9 | 9 | 9 |
| Polyetheramine-DGEBA | 10 | 10 | 10 | 10 | 23 | 23 | 23 | 23 | 23 | | 10 | 10 | 10 | 10 |
| Dyhard 100 SH | 3.5 | 3.5 | 3.5 | 3.5 | 3.5 | 3.5 | 3.5 | 3.5 | 3.5 | 3.5 | 3.5 | 3.5 | 3.5 | 3.5 |
| 2MAOK-PW | 0.53 | 0.53 | 0.53 | 0.53 | 0.53 | | 0.53 | | | 0.53 | | | | 0.53 |
| 2P4MHZ-PW | | | | | | 0.53 | | | 0.88 | | | | | |
| OMICURE U52 | 0.35 | 0.35 | 0.35 | 0.35 | 0.35 | 0.35 | 0.35 | | | 0.35 | 0.88 | | | 0.35 |
| Dyhard UR 700 | | | | | | | | | | | | 0.88 | | |
| Dyhard UR 500 | | | | | | | | | | | | | 0.88 | |
| Fujicure FXR 1030 | | | | | | | | 3.2 | | | | | | |
| CaCO₃ | 20 | 20 | 20 | 20 | 30 | 30 | 30 | 30 | 30 | 20 | 20 | 20 | 20 | 20 |
| CaO | 2 | 2 | 2 | 2 | 2 | 2 | 2 | 2 | 2 | 2 | 2 | 2 | 2 | 2 |
| Garamite 7305 | 2 | 2 | 2 | 2 | 2 | 2 | 2 | 2 | 2 | 2 | 2 | 2 | 2 | 2 |
| XY 966 | 4 | 4 | 4 | 4 | 4 | 4 | 4 | 4 | 4 | 4 | 4 | 4 | 4 | 4 |
| Cellcom AC7000F | 1.6 | 1 | 1 | 0.6 | 0.6 | 0.6 | | | | 1 | 0.6 | 0.6 | 0.6 | 0.4 |
| CF 810 | | | | | | | 0.6 | | 0.6 | | | | | |
| 051 DU 40 | | 0.6 | | 1 | 1 | 1 | 1 | 1 | 1 | 0.6 | 1 | 1 | 1 | |
| 909 DU 80 | | | 0.6 | | | | | | | | | | | |

Table 1 shows compositions of the expandable epoxy adhesive E1-E10 and CE1-CE4.

TABLE 2

| | Curing | | | | | | | | | | |
|---|---|---|---|---|---|---|---|---|---|---|---|
| | temperature, | | | | | | | | | | |
| Test item | curing time | E1 | E2 | E3 | E4 | E5 | E6 | E7 | E8 | E9 | E10 |
| Shear | 140° C., 15 min | 10.1 | 10.5 | 9.7 | 9.7 | 9.3 | 9.7 | 8.5 | 7.2 | 8.8 | 8.2 |
| strength | 140° C., 20 min | 10.3 | 10.6 | 10.2 | 10.3 | 9.2 | 9.5 | 8.7 | 7.4 | 9.0 | 8.5 |
| (MPa) | 150° C., 10 min | 10.5 | 10.5 | 10.1 | 10.2 | 9.3 | 9.7 | 8.6 | 7.3 | 8.8 | 8.6 |
| | 160° C., 10 min | 11.0 | 10.7 | 10.3 | 10.4 | 9.2 | 9.8 | 8.8 | 7.7 | 10.2 | 8.6 |
| | 180° C., 10 min | 11.2 | 11.1 | 10.2 | 11.0 | 9.5 | 9.5 | 9.1 | 8.2 | 11.0 | 8.8 |
| | 180° C., 20 min | 11.9 | 12.0 | 10.3 | 11.2 | 9.4 | 9.6 | 9.4 | 8.7 | 11.2 | 9.3 |
| | 205° C., 30 min | 10.2 | 11.7 | 9.6 | 9.8 | 8.7 | 8.6 | 9.2 | 9.1 | 10.5 | 9.1 |
| T-Peel | 140° C., 15 min | 7.8 | 6.9 | 8.2 | 7.4 | 8.4 | 9.5 | 9.8 | 6.2 | 8.6 | 7.2 |
| strength | 140° C., 20 min | 8.2 | 7.2 | 8.4 | 7.7 | 9.1 | 9.7 | 10.1 | 6.7 | 8.7 | 7.4 |
| (N/mm) | 150° C., 10 min | 8.3 | 7.8 | 8.3 | 8.1 | 9.5 | 9.9 | 11.2 | 7.2 | 9.1 | 7.4 |
| | 160° C., 10 min | 8.7 | 8.2 | 9.2 | 9.2 | 10.2 | 11.2 | 12.2 | 7.3 | 9.4 | 7.8 |
| | 180° C., 10 min | 9.2 | 8.2 | 9.5 | 9.4 | 10.5 | 11.8 | 12.6 | 7.5 | 10.2 | 8.2 |
| | 180° C., 20 min | 9.9 | 8.4 | 10.2 | 9.7 | 11.1 | 12.1 | 13.1 | 7.8 | 10.5 | 8.3 |
| | 205° C., 30 min | 12.3 | 11.4 | 12.2 | 13.2 | 13.2 | 15.2 | 16.9 | 10.1 | 11.2 | 10.9 |
| Expanding | 140° C., 15 min | 52 | 55 | 51 | 60 | 80 | 81 | 101 | 62 | 92 | 52 |
| rate % | 140° C., 20 min | 56 | 58 | 56 | 67 | 85 | 86 | 105 | 64 | 96 | 56 |
| | 150° C., 10 min | 57 | 56 | 54 | 65 | 92 | 94 | 110 | 74 | 106 | 60 |
| | 160° C., 10 min | 62 | 64 | 60 | 69 | 105 | 102 | 118 | 86 | 113 | 64 |
| | 180° C., 10 min | 64 | 65 | 63 | 72 | 156 | 160 | 145 | 89 | 143 | 69 |
| | 180° C., 20 min | 67 | 70 | 66 | 78 | 160 | 165 | 145 | 92 | 149 | 71 |
| | 205° C., 30 min | 64 | 66 | 59 | 75 | 155 | 154 | 140 | 82 | 139 | 63 |

Table 2 shows testing results of the expandable epoxy adhesive E1-E10 and Table 2A shows testing results of the expandable epoxy adhesive CE1-CE4.

TABLE 2A

| | Curing temperature, curing | | | | |
|---|---|---|---|---|---|
| Test item | time | CE1 | CE2 | CE3 | CE4 |
| Shear strength | 140° C., 15 min | 3.2 | 3.6 | 4.1 | 14.7 |
| (MPa) | | | | | |
| | 140° C., 20 min | 3.3 | 4.2 | 5.2 | 15.3 |
| | 150° C., 10 min | 3.4 | 6.7 | 7.0 | 15.2 |
| | 160° C., 10 min | 6.3 | 9.2 | 9.1 | 16.1 |
| | 180° C., 10 min | 8.3 | 9.4 | 9.2 | 16.3 |
| | 180° C., 20 min | 10.4 | 9.7 | 9.5 | 16.9 |
| | 205° C., 30 min | 8.2 | 8.5 | 8.6 | 15.3 |
| T-Peel strength | 140° C., 15 min | 0.5 | 1.2 | 2.1 | 8.1 |
| (N/mm) | | | | | |
| | 140° C., 20 min | 0.7 | 1.8 | 2.8 | 8.2 |
| | 150° C., 10 min | 1.1 | 2.7 | 4.4 | 9.1 |
| | 160° C., 10 min | 6.7 | 8.1 | 8.3 | 10.2 |
| | 180° C., 10 min | 9.8 | 9.6 | 10.2 | 10.9 |
| | 180° C., 20 min | 11.1 | 10.2 | 12.2 | 11.2 |
| | 205° C., 30 min | 14.2 | 14.5 | 15.2 | 14.2 |
| Expanding rate % | 140° C., 15 min | 56 | 60 | 47 | 30 |
| | 140° C., 20 min | 66 | 68 | 48 | 34 |
| | 150° C., 10 min | 86 | 87 | 82 | 40 |
| | 160° C., 10 min | 102 | 108 | 110 | 42 |
| | 180° C., 10 min | 150 | 156 | 140 | 46 |
| | 180° C., 20 min | 157 | 160 | 147 | 50 |
| | 205° C., 30 min | 150 | 152 | 139 | 46 |

From the table, we can find the designed accelerant and foaming agent can help the low temperature curing of at least 140° C. for 15 mins and the formulations have good expanding performances (>50% expanding rate). Also, all cured and foamed compositions of E1 to E9 provide the high T peel strength (>6 N/mm) and shear strength (>6 MPa).

It can be seen from CE1 to CE3, the comparative compositions comprise different comparative accelerants, and the compositions cured and foamed at 140° C. for 15 mins can't achieve desired strength performance and expanding performance. Although the strength performance and expanding performance can be improved when the same compositions were cured and foamed at higher curing temperatures, but the compositions are not suitable for low temperature curing or foaming process. Detailly, when the compositions of CE1 to CE3 were cured and foamed at 180° C. for 15 mins, the strength performance (peel strength (>6 N/mm) and shear strength (>6 MPa)) and expanding performance (>50% expanding rate) of cured and foamed product are qualified. If the operating condition changes to lower temperature, for example 150° C. or 140° C., the compositions are not suitable, and the products can't achieve desired strength performance and expanding performance.

Compared with E1, CE4 comprises only 0.4 parts by weight of foaming agent, too little foaming agent makes lower expanding rate.

In Examples 1 to 10, the expandable epoxy compositions were prepared according to the formulations provided by the present invention. These formulations especially included the epoxy resin, toughening agent, designed accelerant, foaming agent and curing agent. It can be seen that when the contents of the claimed components of the present invention are within certain ranges, the prepared epoxy compositions could be cured and foamed at lower temperature (such as 140° C. to 150° C.). And the curing and forming temperature range is expanded to at least 140° C. to 205° C.

It can be seen from E8 that the substituted amine accelerant has lower strength performance at lower curing and foaming temperatures.

What is claimed is:

1. An expandable epoxy composition, comprising:
a) at least one epoxy resin,
b) a toughening agent, a
c) an accelerant,
d) a foaming agent, and
e) a curing agent,
wherein the expandable epoxy composition has a T peel strength pursuant to ASTM D1876 at 23° C. of equal to or greater than 6 N/mm, a shear strength pursuant to SAE J1523 at 23° C. of equal to or greater than 6 MPa, and an expanding rate % of equal to or greater than 50%, after curing and foaming the expandable epoxy composition at 140° C. for 15 minutes.

2. The expandable epoxy composition of claim 1, wherein the expandable epoxy composition has a shear strength pursuant to SAE J1523 at 23° C. of equal to or greater than 7 MPa.

3. The expandable epoxy composition of claim 1, wherein the expandable epoxy composition has a T peel strength pursuant to ASTM D1876 at 23° C. of equal to or greater than 6 N/mm, a shear strength pursuant to SAE J1523 at 23° C. of equal to or greater than 6 MPa, and an expanding rate % of equal to or greater than 50%, after curing and foaming the expandable epoxy composition at 140° C. for 20 minutes.

4. The expandable epoxy composition of claim 1, wherein the expandable epoxy composition has a T peel strength pursuant to ASTM D1876 at 23° C. of equal to or greater than 6 N/mm, a shear strength pursuant to SAE J1523 at 23° C. of equal to or greater than 6 MPa, and an expanding rate % of equal to or greater than 50%, after curing and foaming the expandable epoxy composition at 150° C. for 10 minutes.

5. The expandable epoxy composition of claim 1, wherein the expandable epoxy composition has a T peel strength pursuant to ASTM D1876 at 23° C. of equal to or greater than 6 N/mm, a shear strength pursuant to SAE J1523 at 23° C. of equal to or greater than 6 MPa, and an expanding rate % of equal to or greater than 50%, after curing and foaming the expandable epoxy composition at 160° C. for 10 minutes.

6. The expandable epoxy composition of claim 1, wherein the expandable epoxy composition has a T peel strength pursuant to ASTM D1876 at 23° C. of equal to or greater than 6 N/mm, a shear strength pursuant to SAE J1523 at 23° C. of equal to or greater than 6 MPa, and an expanding rate % of equal to or greater than 50%, after curing and foaming the expandable epoxy composition at 180° C. for 10 minutes.

7. The expandable epoxy composition of claim 1, wherein the expandable epoxy composition comprises:
a) the at least one epoxy resin present in an amount of 10-45 parts by weight,
b) the toughening agent present in an amount of 15-60 parts by weight,
c) the accelerant present in 0.1-4.0 parts by weight,
d) the foaming agent present in 0.5-3.0 parts by weight,
e) an effective amount of the curing agent,
wherein the accelerant comprising at least a substituted amine, a substituted imidazole or a combination of substituted urea and substituted imidazole, and the foaming agent comprising at least a chemical foaming agent, a physical foaming agent or a combination thereof.

8. The expandable epoxy composition of claim 7, wherein the at least one epoxy resin is selected from the group consisting of diglycidyl ethers of bisphenol A or bisphenol F.

9. The expandable epoxy composition of claim 7, wherein the expandable epoxy composition comprises from 15 to 30 parts by weight of the epoxy resin.

10. The expandable epoxy composition of claim 7, wherein the accelerant comprises a substituted amine in an amount of 1.0-4.0 parts by weight.

11. The expandable epoxy composition of claim 7, wherein the accelerant comprises a substituted imidazole in an amount of 0.3-1.0 parts by weight.

12. The expandable epoxy composition of claim 7, wherein the accelerant comprises a combination of substituted urea and substituted imidazole in an amount of 0.5-1.5 parts by weight.

13. The expandable epoxy composition of claim 12, wherein the mass ratio of the substituted imidazole to the substituted urea is from 1:2 to 4:1.

14. The expandable epoxy composition of claim 7, wherein the chemical foaming agent comprising azo-compound and the physical foaming agent comprising expanded microspheres.

15. The expandable epoxy composition of claim 7, wherein the toughening agent comprises one or more selected from rubber, capped polyurethane prepolymer and polyetheramine-epoxy prepolymer.

16. The expandable epoxy composition of claim 15, wherein the polyetheramine-epoxy prepolymer is a reaction product of:
a) a difunctional epoxy;
b) a rubber dicarboxylic acid or a rubber diamine; and
c) a polyamine comprising aliphatic chain,
wherein the difunctional epoxy is selected from bisphenol A, or bisphenol F, or bisphenol S, or halogenated bisphenol; wherein the rubber dicarboxylic acid and the rubber diamine, comprise a rubber chain selected from polybutadiene, or polyacrylonitrile, or polypentadiene; and the polyamine comprising aliphatic chain is selected from polyamines having aliphatic chain of 10 to 400 carbon atoms.

17. The expandable epoxy composition of claim 15, wherein the expandable epoxy composition comprises from 5 to 30 or 10 to 25 parts by weight of the polyetheramine-epoxy prepolymer.

18. A method of making an article comprising a cured and foamed epoxy composition which comprises:
a) applying the expandable epoxy composition of claim 1 on a first substrate of an article;
b) optionally, attaching a second substrate to the first substrate, and
c) curing and foaming the article at a temperature of from 120° C. to 205° C. for at least 20 to 5 mins.

19. The method of claim 18, wherein the temperature of curing and foaming the article is from 140° C. to 180° C. for at least 15 to 7 mins.

20. The method of claim 18, wherein at least one of the substrates is metal.

21. A structural adhesive comprising a cured and foamed product of the expandable epoxy composition according to claim 1.

22. An article comprising a first substrate, a second substrate and a cured/foamed composition disposed between and adhering the first substrate and the second substrate, wherein the cured/foamed composition is the cured/foamed product of the expandable epoxy composition according to claim 1.

23. An automotive frame, comprising the article of claim 22.
